(19) United States
(12) Patent Application Publication
(10) Pub. No.: US 2025/0218434 A1
(43) Pub. Date: Jul. 3, 2025

(54) AUTOMATED PROMPT FINDER

(71) Applicant: CX360, Inc., Omaha, NE (US)

(72) Inventors: Laura J. Kleiman, Omaha, NE (US); Patrick M. Peterson, Omaha, NE (US); Rick Marvel, Omaha, NE (US)

(21) Appl. No.: 18/400,374

(22) Filed: Dec. 29, 2023

(51) Int. Cl. G10L 15/22; G10L 25/51

(52) U.S. Cl. CPC G10L 15/22; G10L 25/51

(57) ABSTRACT

There is disclosed herein a computer-assisted method of identifying prompts from a batch of recorded interactive voice response (IVR) calls, including: identifying, within a call under analysis, a plurality of discrete utterances; electronically comparing a selected utterance to a set of known prompt candidates, wherein the known prompt candidates are candidates for being IVR prompts; based on the comparing, determining that the selected utterance clusters with a known prompt candidate cluster, and accumulating a counter for the prompt candidate cluster; and after processing the batch, identifying a set of good prompt candidates, wherein good prompt candidates have a counter above a threshold.

### FIELD OF THE SPECIFICATION

The present specification relates to computer automation, and more particularly to an automated prompt finder for an interactive voice response (IVR) system.

### BACKGROUND

IVR is commonly used for customer service, although it has other applications as well. IVR is a technology in which a script or prompt tree uses pre-recorded prompts to guide a user in responding to various menu options. Technologies, such as DTMF tones and speech recognition, can be used to recognize a user's responses to the prompts and proceed to the next step in the tree, ultimately connecting the user to the correct or preferred electronic resources or to a customer service agent, if necessary, while providing the customer service agent with useful context.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of an IVR ecosystem.

FIG. 2 is a block diagram of selected elements of an IVR system improvement cycle.

FIG. 3 is a block diagram of selected elements of a call analysis platform.

FIG. 4 provides a flowchart, which illustrates an audio method of automating prompt finding.

FIG. 5 provides a flowchart, which illustrates a text method of automating prompt finding.

FIG. 6 is a block diagram illustration of prompt candidate mapping.

FIG. 7 is an illustration of a GUI for a call browser.

FIG. 8 is an illustration of a GUI display of an audio prompt taxonomy.

FIGS. 9a and 9b provide an illustrative spreadsheet output from a prompt text finding batch, to support reviewing prompts in calls.

FIGS. 10a and 10b provide an illustrative spreadsheet output with additional aspects of output from a prompt text finding batch.

FIG. 11 is a block diagram of selected elements of a hardware platform.

FIG. 12 is a block diagram of selected elements of a network function virtualization (NFV) infrastructure.

FIG. 13 is a block diagram of selected elements of a containerization infrastructure.

### SUMMARY

There is disclosed herein a computer-assisted method of identifying prompts from a batch of recorded interactive voice response (IVR) calls, including: identifying, within a call under analysis, a plurality of discrete utterances; electronically comparing a selected utterance to a set of known prompt candidates, wherein the known prompt candidates are candidates for being IVR prompts; based on the comparing, determining that the selected utterance clusters with a known prompt candidate cluster, and accumulating a counter for the prompt candidate cluster; and after processing the batch, identifying a set of good prompt candidates, wherein good prompt candidates have a counter above a threshold.

### Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Overview

To evaluate and improve the performance of IVRs, analysts can observe patterns of prompts and responses for various user tasks to determine how efficiently and accurately an IVR guides users to solve their problems. In some systems, the first step in this process is detecting just the prompts, which can be done very accurately with signal processing using short, less than one-second, snippets of the prerecorded prompts.

The most time-consuming step in prompt-based analytics is in identifying and extracting prompt snippets, which often requires analysts to search through call recordings, listening for prompts and marking them for extraction. For a typical IVR with hundreds of prompts, this can take weeks. The present specification teaches a system to find prompt candidates automatically. In an illustrative case, use of this system and method reduces analyst effort from weeks to days.

Such analytics can greatly improve IVR systems, which are highly beneficial to service providers in that they can substantially reduce the number of customer service agents necessary to handle user queries. However, IVRs are very sensitive to user experience. If end users feel like the IVR is getting in the way of answering questions or resolving situations, the user may feel frustration and perceive a poor customer service experience. A frustrated user may terminate the IVR call and, in cases of more extreme frustration, a poorly designed IVR may result in lost sales or subscriptions to the provider.

Because of this, feedback often plays an important part in IVR system design. Feedback can be used to improve menu options, reduce the number of steps a user requires to get to the desired answer, help to identify when it is beneficial to connect the user to a customer service agent outside of the IVR, to evaluate the effectiveness of decision trees in the IVR, and ultimately to provide an improved user experience so that both the service provider and the customer can realize the benefits of the IVR technology.

Thus, analysis and feedback for IVR systems may form an industry of its own. Feedback infrastructures commonly include a human analyst who analyzes recorded customer service calls which may be recorded with the end user's knowledge or permission. The human analyst may analyze the call, determine the effectiveness of the IVR, and recommend options for improving the user's IVR experience.

While such human analysis provides beneficial feedback, the initial intake of a call set may be a substantial bottleneck in the system. In some cases, a large batch of calls comes in (e.g., on the order of hundreds or thousands of calls), and human analysts must first tag the calls so that they can be effectively analyzed. This may include listening to the calls and manually identifying instances of IVR prompts. The human analyst can then tag the call recording with timestamps for the prompts and may also look up the prompts in a prompt tree or taxonomy to identify which prompt correlates to the timestamp. The same or a different human analyst can then use a call browser, which may be a graphical user interface (GUI), to listen to the prompts, listen to the user's responses, assign to the call a level of success, and provide recommendations for how to improve the IVR system.

In an illustrative GUI, the call browser records customer service calls and uses signal processing technology to detect known audio prompts that are played to the caller from the IVR. The sequence of detected prompts can be analyzed automatically to determine call properties and to prepare automated reports. One foundational aspect of the call browser is to associate prompts with timestamps in the call.

In an existing system, a human analyst may save prompt samples with a snippet of less than a second. The snippet may be, for example, between 600 milliseconds and 1000 milliseconds or, more particularly, approximately 800 milliseconds. The human analyst can manually identify prompts and cut out short samples to pinpoint relevant prompts of interest.

In some existing systems, when the call browser is initially set up or when clients update their IVRs, analysts must listen to many calls and review transcripts to find prompts that are not already being automatically detected. The human analysts then find and extract distinctive, short (e.g., less than one second) audio prompt snippets that can be used in other calls to detect prompts of interest.

With initial intake of a new client for an IVR feedback service provider, the initial analysis may take several weeks for analysts to identify, tag, and propagate snippets that can be used to identify prompts of interests in later calls. This may represent a lead time during which the feedback service provider is not providing substantive feedback to the IVR client, but rather is simply performing set up of the system. Furthermore, when the IVR changes, a human analyst may need to repeat the task. Depending on the extent of the changes, this may once again take several weeks of human effort before substantive feedback is available to the IVR client.

In summary, an IVR feedback cycle may include several distinct phases. In a first phase, one or more human analysts listen to a large number of calls, identify IVR prompts manually, manually cut out prompt snippets of approximately 800 milliseconds each, and store these prompt snippets in a database. In a second phase, signal processing software is run on a large number of IVR calls that have been submitted for analysis. The signal processing software scans the recorded call for instances of the known IVR prompts and automatically tags calls with the prompt location and an identifier, such as a taxonomic identifier for the prompt.

In the third phase, one or more human analysts analyze the calls to determine the effectiveness of the IVR, the success rate, and other quality factors. The IVR feedback service provider can then make substantive recommendations to the IVR client on how to improve the IVR system.

The prompt finder of the present specification reduces the need for human intervention in the first phase of the IVR feedback process. The prompt finder may analyze a set of IVR call recordings and queue call segments within the call browser. This can be done, for example, in a call browser. The system may then use appropriate automated techniques to identify a number of candidate IVR prompts within the calls. One meaningful observation that aids in identifying IVR prompts is that computers tend to be much more repetitive than humans and, in particular, computers tend to be much more repetitive than a selection of different humans. While humans may use a variety of wording, vocal cadences, pitch, tone, and other variations in language to convey similar meaning, an IVR prompt is generally a pre-recorded sample that is substantially identical across instances. Thus, if an identical or nearly identical audio snippet recurs throughout a plurality of call recordings, this snippet is most likely an IVR prompt. While it is conceivable to have false positives, such as in cases where a human repeats himself or herself, or multiple humans sound nearly identical, such instances of false positives are rare enough that they can be manually eliminated by a human analyst without adding a substantial analysis burden. Illustrative and nonlimiting examples of methods for identifying prompts include audio comparison and text comparison. In an audio comparison example, the system may identify common audio snippets using a signal processor with appropriate settings for a selected performance. This method can fully automate prompt finding and may find the best possible prompt exemplar but may take longer, may take more computer resources due to stricter matching criteria, and may fail to find less frequent prompts. A text comparison may use a fast, text-only comparison that finds most prompts and supports human review and choice of snippets to be extracted, but may not support finding the best prompt exemplar.

### SELECTED EXAMPLES

The foregoing can be used to build or embody several example implementations, according to the teachings of the present specification. Some example implementations are included here as nonlimiting illustrations of these teachings.

There is disclosed by way of example, a computer-assisted method of identifying prompts from a batch of recorded interactive voice response (IVR) calls, comprising: identifying, within a call under analysis, a plurality of discrete utterances; electronically comparing a selected utterance to a set of known prompt candidates, wherein the known prompt candidates are candidates for being IVR prompts; based on the comparing, determining that the selected utterance clusters with a known prompt candidate cluster, and accumulating a counter for the known prompt candidate cluster; and after processing the batch, identifying a set of good prompt candidates, wherein good prompt candidates have a counter above a threshold.

There is further disclosed an example, further comprising determining that the selected utterance does not cluster with a known prompt candidate, and designating the selected utterance as a prompt candidate.

There is further disclosed an example, wherein the threshold is a scalar threshold.

There is further disclosed an example, wherein the threshold is a prevalence threshold.

There is further disclosed an example, wherein the discrete utterances are delimited by silence.

There is further disclosed an example, wherein the discrete utterances are delimited by silence above a threshold length.

There is further disclosed an example, wherein the discrete utterances are delimited by tonal or vocal shift.

There is further disclosed an example, wherein electronically comparing comprises comparing audio waveforms.

There is further disclosed an example, wherein electronically comparing comprises comparing call transcripts.

There is further disclosed an example, wherein comparing call transcripts comprises comparing average word embeddings for utterances.

There is further disclosed an example, wherein comparing call transcripts comprises comparing for cosine similarity.

There is further disclosed an example, further comprising outputting a matrix of the good prompt candidates.

There is further disclosed an example, further comprising cutting short initial snippets for the good prompt candidates.

There is further disclosed an example, wherein the short initial snippets are less than one second.

There is further disclosed an example, wherein the short initial snippets are approximately 800 milliseconds.

There is further disclosed an example, further comprising tagging a set of call recordings with timestamps of identified IVR prompts within the call recordings.

There is further disclosed an example, further comprising supplementing prompt identification with additional human analysis.

There is further disclosed an example of an apparatus comprising means for performing the method.

There is further disclosed an example, wherein the means for performing the method comprise a processor and a memory.

There is further disclosed an example, wherein the memory comprises machine-readable instructions that, when executed, cause the apparatus to perform the method.

There is further disclosed an example, wherein the apparatus is a computing system.

There is further disclosed an example of least one computer readable medium comprising instructions that, when executed, implement a method or realize an apparatus as described.

There is further disclosed an example of one or more tangible, nontransitory computer-readable storage media having stored thereon executable instructions to instruct a processor circuit to: receive a batch of interactive voice response (IVR) call recordings; identify, within a selected call from the batch, a plurality of utterances; electronically compare a selected utterance to a set of previously-identified IVR prompt candidates; based on the comparing, determine that the selected utterance clusters into a previously-identified prompt candidate cluster, and increasing a count for the candidate cluster; and after processing the batch, identify a set of good prompt candidates, based on counts for the candidate clusters.

There is further disclosed an example, wherein the instructions are further to determine that the selected utterance does not cluster with a known prompt candidate, and designating the selected utterance as a prompt candidate.

There is further disclosed an example, wherein the counts include a scalar value.

There is further disclosed an example, wherein the counts include a prevalence model.

There is further disclosed an example, wherein the plurality of utterances are delimited by silence.

There is further disclosed an example, wherein the plurality of utterances are delimited by silence above a threshold length.

There is further disclosed an example, wherein the plurality of utterances are delimited by tonal or vocal shift.

There is further disclosed an example, wherein electronically comparing comprises comparing audio waveforms.

There is further disclosed an example, wherein electronically comparing comprises comparing call transcripts.

There is further disclosed an example, wherein comparing call transcripts comprises comparing average word embeddings for utterances.

There is further disclosed an example, wherein comparing call transcripts comprises comparing for cosine similarity.

There is further disclosed an example, wherein the instructions are further to output a matrix of the good prompt candidates.

There is further disclosed an example, wherein the instructions are further to cut short initial snippets for the good prompt candidates.

There is further disclosed an example, wherein the short initial snippets are less than one second.

There is further disclosed an example, wherein the short initial snippets are approximately 800 milliseconds.

There is further disclosed an example, wherein the instructions are further to tag a set of call recordings with timestamps of identified IVR prompts within the call recordings

There is further disclosed an example, wherein the instructions are further to receive supplemental identification from human analysis.

There is further disclosed an example, wherein the instructions are further to provide a call browser graphical user interface (GUI), with prompts identified within the call browser.

There is further disclosed an example of a computing apparatus for automatically identifying prompts within a batch of recordings of interactive voice response (IVR) calls, comprising: a hardware platform comprising a processor circuit and a memory; and instructions encoded within the memory to instruct the processor circuit to: identify, within a selected call from the batch, a plurality of utterances; electronically compare a selected utterance to a set of previously-identified IVR prompt candidates; based on the comparing, determine that the selected utterance clusters into a previously-identified prompt candidate cluster, and increasing a count for the candidate cluster; and after processing the batch, identify a set of good prompt candidates, based on counts for the candidate clusters.

There is further disclosed an example, wherein the instructions are further to determine that the selected utterance does not cluster with a known prompt candidate, and designating the selected utterance as a prompt candidate.

There is further disclosed an example, wherein the counts include a scalar value.

There is further disclosed an example, wherein the counts include a prevalence model.

There is further disclosed an example 1, wherein the plurality of utterances are delimited by silence.

There is further disclosed an example, wherein the plurality of utterances are delimited by silence above a threshold length.

There is further disclosed an example, wherein the plurality of utterances are delimited by tonal or vocal shift.

There is further disclosed an example, wherein electronically comparing comprises comparing audio waveforms.

There is further disclosed an example, wherein electronically comparing comprises comparing call transcripts.

There is further disclosed an example, wherein comparing call transcripts comprises comparing average word embeddings for utterances.

There is further disclosed an example, wherein comparing call transcripts comprises comparing for cosine similarity.

There is further disclosed an example, wherein the instructions are further to output a matrix of the good prompt candidates.

There is further disclosed an example, wherein the instructions are further to cut short initial snippets for the good prompt candidates.

There is further disclosed an example, wherein the short initial snippets are less than one second.

There is further disclosed an example, wherein the short initial snippets are approximately 800 milliseconds.

There is further disclosed an example, wherein the instructions are further to tag a set of call recordings with timestamps of identified IVR prompts within the call recordings.

There is further disclosed an example, wherein the instructions are further to receive supplemental identification from human analysis.

There is further disclosed an example, wherein the instructions are further to provide a call browser graphical user interface (GUI), with prompts identified within the call browser.

### DETAILED DESCRIPTION OF THE DRAWINGS

A system and method for an automatic prompt finder will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

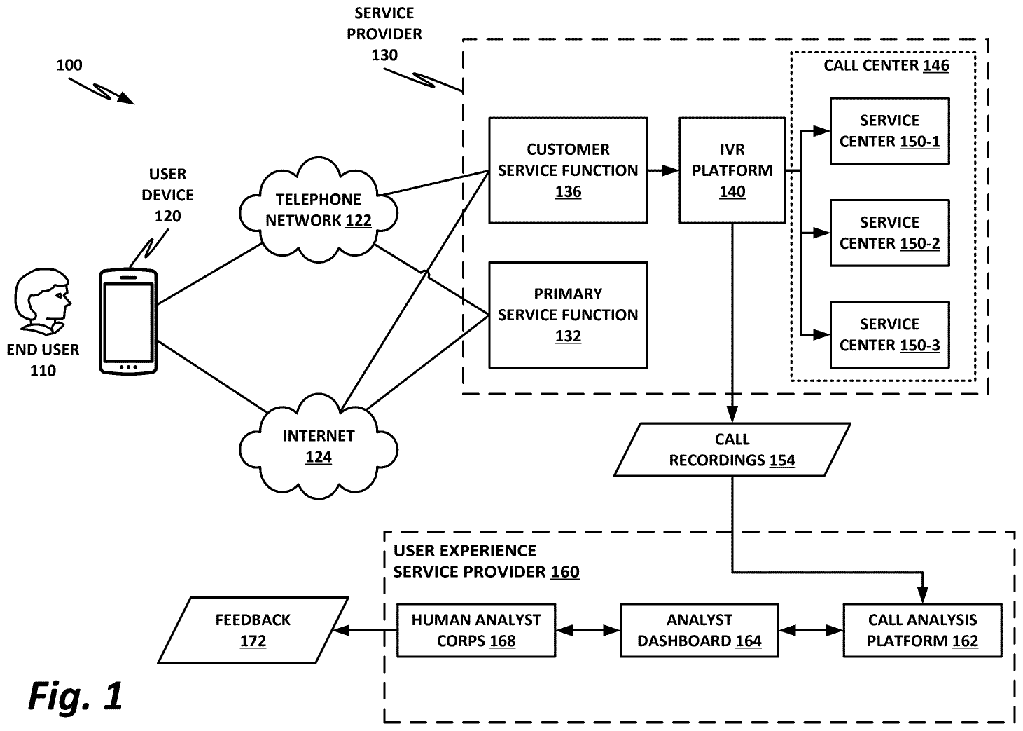

FIG. 1 is a block diagram of selected elements of an IVR ecosystem 100. IVR ecosystem 100, in this illustration, includes three major players, namely an end user 110, a service provider 130, and a user experience service provider 160. Service provider 130 provides a primary service function 132 to end user 110. For example, service provider 130 may be a phone company, a bank, a cellular provider, an e-commerce provider, or other service provider that may benefit from an IVR.

Primary service function 132 includes the substantive service that service provider 130 provides to end users 110. For example, if service provider 130 is a mobile phone service, then its primary service function is providing mobile telephony to its customers.

In support of the primary service function 132, service provider 130 may also include a customer service function 136. Customer service function 136 may be an auxiliary to primary service function 132, and may handle customer questions, complaints, service requests, and other support functions. Customer service function 136 may operate an IVR platform 140. End user 110 may access customer service function 136 using a user device 120, such as a cell phone or landline phone, via telephone network 122, which may be a cellular network, a digital network, voice over IP, public switched telephone network (PSTN), or other appropriate network.

In an illustrative service example, end user 110 operates user device 120 to call service provider 130 via telephone network 122. Service provider 130 connects user device 120 to customer service function 136. Customer service function 136 accesses IVR platform 140, which may include a number of automated prompts in a prompt tree that attempts to connect the user to the appropriate service or resource.

A prompt tree is provided as a nonlimiting example only. Some modern call centers have evolved to Interactive Voice Assistants (IVAs), which are more conversational and are not limited to a fixed decision tree. The IVAs can make customer service function 136 much more flexible, goal-directed, and based on caller initiative to capture information in whatever order the caller provides. For example, an airline reservation may need a dozen pieces of information and, if given the chance, callers may provide multiple pieces at a time: “I need two seats from Boston to San Antonio on the 15th”.

Prompt Detection can still be valuable for IVAs, for example in tracking the machine's responses to the caller's query or information. The automated prompt finder system and method of the present specification is applicable to such IVAs, for example by searching for multiple prompts at various points in one long utterance.

A call center 146 may include a plurality of service centers 150-1, 150-2, and 150-3, for example. One function of IVR platform 140 is to timely connect end user 110 to an appropriate service center 150 to handle the issue or concern presented by end user 110. Service centers 150 may include one or both of human customer service agents and electronic resources.

In addition to a voice telephone network 122, end user 110 may use device 120 to access internet 124, which may connect end user 110 to both primary service function 132 and customer service function 136. Modern customer service centers often include a chatbot or other electronic version of the IVR. The chatbot may perform a similar function to that of the IVR and may have a number of prompts and a decision tree to attempt to route user 110 to the appropriate service center 150. In general terms, a successful customer service interaction may be defined as one in which user 110 is timely routed to the appropriate service center 150, and the service center 150 is able to resolve the customer's concern or issue to the customer's satisfaction. An unsuccessful customer service interaction is one in which the customer becomes frustrated, angry, or one in which the concern is not resolved to the customer's satisfaction. Furthermore, even if customer service function 136 successfully resolves end user 110's concern, if the resolution is not timely, then the customer may nevertheless feel unsatisfied, which represents, at best, a partial success for customer service function 136.

Thus, it may be a goal of IVR platform 140 to timely connect end user 110 to an appropriate service center 150 in such a way that end user 110's issue or concern is timely and satisfactorily resolved.

To provide more and better service interactions, service provider 130 may contract with user experience service provider 160 to improve IVR platform 140. For example, it is common to inform users of an IVR system that their calls may be recorded for training and quality assurance. When those calls are recorded, a large batch of call recordings 154 can be sent to user experience service provider 160. User experience service provider 160 may operate a call analysis platform 162, which may include a database of known IVR prompts, derived either automatically or via human intervention, or a combination of the two. Call analysis platform 162 may analyze and tag calls by recognizing IVR prompts, tagging them with timestamps, and associating them with a taxonomic identification that a human analyst can use to assess the value and success of given prompts.

An analyst dashboard 164 may include one or more computing systems that provide a user interface, such as a GUI, that a human analyst corps 168 can use to analyze IVR calls to determine their success and effectiveness. The human analyst corps 168 can then provide feedback to the service provider 130, in the form of analysis and recommendations 172, which service provider 130 can use to improve IVR platform 140.

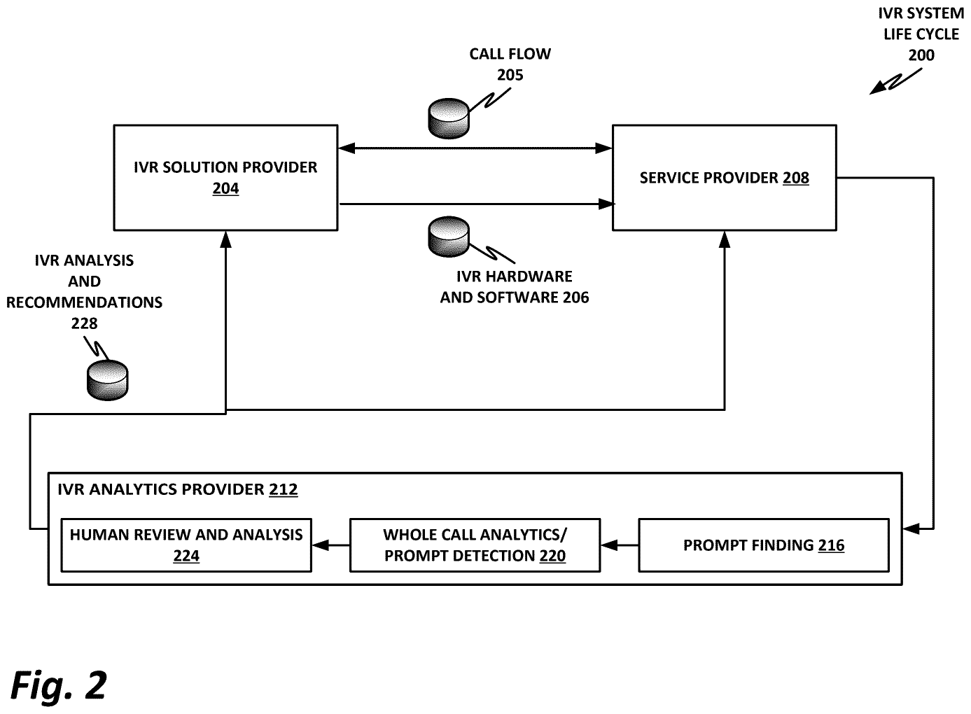

FIG. 2 is a block diagram of selected elements of an IVR system improvement cycle 200. IVR system improvement cycle 200 illustrates interactions between an IVR solution provider 204, a service provider 208, and an IVR analytics provider 212.

IVR solution provider 204 is the original vendor of hardware and software to provide a comprehensive IVR solution to service provider 208. IVR solution provider 204 provides the initial programming and setup of the IVR system hardware and software. IVR solution provider 204 may work closely with service provider 208 to identify call flows 205. Call flows 205 may include a call tree, or they may include training data for a more flexible interactive voice system. Once IVR solution provider 204 has the appropriate call flows 205, it may program the IVR system and deliver IVR hardware and software 206 to service provider 208.

Service provider 208 purchases and operates the IVR system as part of its customer service function, and operates the IVR system for a time to provide services to its customers.

After some use of the IVR system, service provider 208 may wish to improve IVR hardware and/or software 206 for example, to ensure that end users have a better customer service experience. To this end, service provider 208 may contract with an IVR analytics provider 212. IVR analytics provider 212 may be the same enterprise as IVR solution provider 208, or may be a completely separate enterprise.

IVR analytics provider 212 provides analysis of the IVR system. This includes a pipeline that provides, for example, prompt finding 216, whole call analytics and prompt detection 220, and human review and analysis 224. Certain aspects of the present disclosure are particularly concerned with prompt finding 216. In existing architectures, prompt finding 216 may take several weeks of human operators analyzing calls, identifying prompts, clustering prompts, and cutting out sharper short representative snippets. These snippets can then be used in whole call analytics and prompt detection 220. An output of whole call analytics 220 is a set of calls that have been appropriately analyzed and tagged, which can then be provided to a human analysis corps, which provides review and recommendation.

IVR analytics provider 212 may provide analysis and recommendations 228, which in appropriate circumstances may be provided to service provider 208 and/or to IVR solution provider 204 to improve the IVR system.

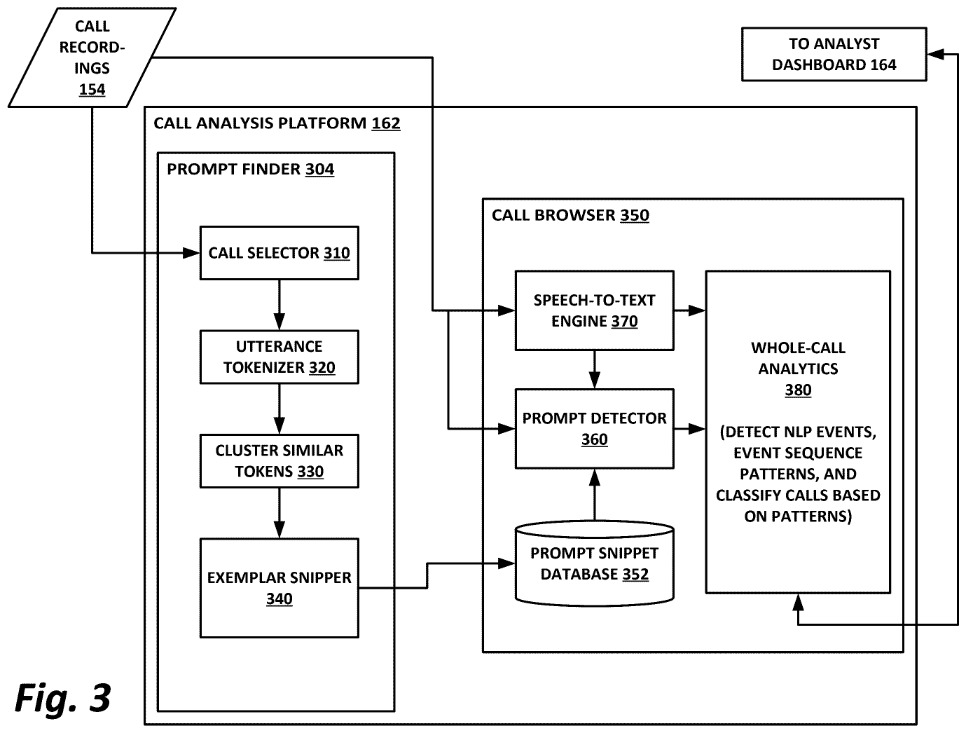

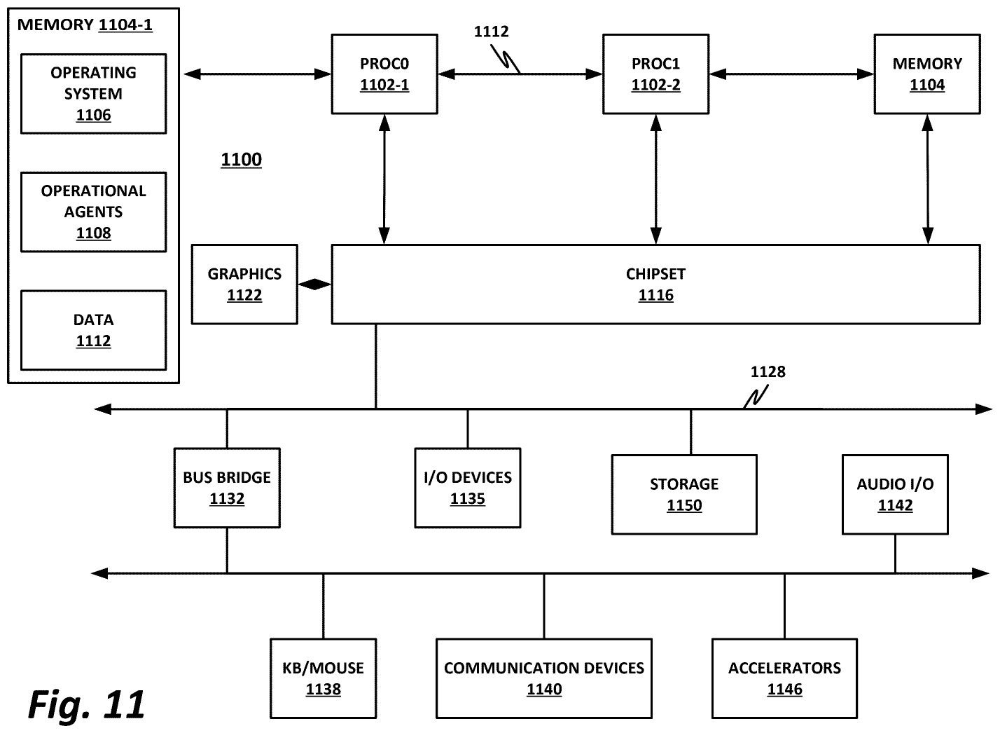

FIG. 3 is a block diagram of selected elements of a call analysis platform 162. Call analysis platform 162 may run on one or more hardware platforms, for example as illustrated in FIG. 11 below.

Call analysis platform 162 includes a prompt finder 304 and a call browser 350. Prompt finder 304 may include hardware and software elements to identify clusters of similar prompts, including designating a representative snippet (exemplar) for each cluster. As discussed above, the system and method disclosed herein can substantially streamline the process of prompt finding, for example reducing the lead time from weeks to days or hours. Call browser 350 may facilitate prompt detection, in which calls are analyzed to detect and tag known prompts that match to an exemplar. Calls that have been tagged in call browser 350 can then be provided to an analyst dashboard 164, where a human or AI analyst can assess the effectiveness of calls and provide recommendations for improvement of the IVR system.

Prompt finder 304 may include a call selector 310, which selects an input batch of call recordings 154 for analysis. The input batch may be selected using criteria such as batch size, recording properties like call source or destination, or any other relevant criteria.

Call Selector 310 may be followed by an Utterance Tokenizer 320, which may include hardware or software to, firstly, identify discrete utterances within the call. An utterance may be defined, for example, as an instance of speech after a period of silence, such as 100 milliseconds, which period may be configurable. Furthermore, tokenizer 320 may identify IVR utterances by detecting different tones, pitch, speech patterns, or similar. For example, the computerized IVR recordings may have different pitch, tone, and speech patterns than non-IVR-voice sources of audio in the IVR channel.

Tokenization may then take two forms to create either audio or text tokens to support audio or text clustering methods. In cases where audio clustering is used, the utterance token would be a short, typically 800 ms, audio snippet taken, typically, from near the start of the utterance. In cases where text clustering is used in prompt finding, utterances may be represented by, or divided into, discrete text tokens representing all or part of the utterance, which can be compared more quickly, and with fewer compute resources, than can audio snippets.

Tokenizer 320 may provide discrete tokens to clustering module 330, which may include hardware or software elements to identify similar utterances that are to be grouped together (such as utterances that appear to be the same or a similar IVR prompt). Depending on token type, clustering may include identifying audio similarity (for example, via digital signal processing), or textual similarity (for example, via text comparison after speech-to-text conversion). Clustering module 330 may include a frequency model, which determines how frequently certain utterances occur throughout the call set. Utterances that occur more frequently may be more likely to be IVR prompts, because a computer is more likely to repeat substantially exact phrases than a human.

Once prompt candidates have been clustered by either audio or text methods, exemplar snipper 340 typically snips a short, representative audio segment (snippet) for each candidate cluster that can be used to identify other instances of the same prompt. The snippet may, for example, be taken from the beginning of an utterance sample, and may comprise a short audio snippet of less than one second, or more particularly of approximately 800 milliseconds. Exemplar snipper 340 may be totally automated or partially manual, where analysts control the snippet end-points to capture higher quality exemplars. This manual process may not significantly detract from the time savings realized by the automatic identification of the utterance and position in the utterance of the candidate prompt snippet.

In the case of prompt detection using text comparison, instead of cutting a representative audio snippet, exemplar snipper 340 may take a representative sample (snippet) of text. This is typically less than the full length of the prompt but longer than an 800 millisecond audio exemplar because text comparison is more accurate for longer samples, while still being faster and lighter on compute resources than audio comparison. Because speech-to-text transcription is not always exact, the comparison may be a fuzzy comparison or may use NLP algorithms that recognize similar text, even if they do not match exactly.

Prompt finder 304 may provide representative prompt snippets, which could be audio or text, to call browser 350, which may store the prompt snippets in a prompt snippet database 352, which may also associate with the prompt token metadata, such as taxonomic designations of prompt tokens (if the prompts are in a prompt tree), or other identifying information that may be used to uniquely identify each prompt and its role in the IVR system.

Extracted snippets can be used to automatically tag calls that flow into the call browser, where analysts examine calls and provide analysis and recommendations.

Call browser 350 may include a speech-to-text engine 370, which provides a machine-generated transcript of the call. Although such transcripts are not always consistent with the intended speech, they provide enough information to be useful for call analysis.

A prompt detector 360 accesses prompt snippet database 352, which has short audio or text snippets that were identified by prompt finder 304. For audio snippets, prompt detector 360 may scan the set of calls for instances of the identified prompt snippets, and may then designate the full utterance associated with the snippet as a prompt. Prompt detector 360 may also tag the utterance with the prompt metadata. In some cases, detection and tagging may be a joint human/machine operation, wherein the computer provides initial tagging, and human operators may correct the detection as necessary.

Prompt detector 360 may also use text snippets from prompt snippet database 352 and text transcripts from speech-to-text engine 370 to find prompts within calls. Text matching may be based on exact text matching, regular expressions, fuzzy matching, and/or NLP in appropriate embodiments.

Prompt detector 360 provides detected prompts to whole-call analytics module 380. Whole-call analytics module may also receive text transcripts from speech-to-text engine 370. With calls tagged with the appropriate prompts, and with text transcripts, whole-call analytics module 380 may perform additional analysis on each call. This may include, for example, detecting NLP events, detecting event sequences and patterns, and classifying calls based on patterns. As with other blocks, in at least some embodiments, this may include cooperative machine-human efforts.

For example, whole-call analytics module 380 may select prompts from prompt snippets database 352 to reduce selected calls for analysis into a tree of IVR prompts. In some analysis regimens, human utterances are less important than identifying the tree logic that the IVR prompts follow and identifying the overall results of the call. However, human utterances may be useful in analyzing human responses or sentiments (e.g., some IVR systems, instead of using DTMF, use voice recognition and ask a user to say a number or ask a particular question), in which case human utterances may be useful for matching those utterances to the correct IVR response to determine whether the IVR correctly routed the call or correctly followed the tree based on the human utterances. Sentiment may also be useful in assessing a user's happiness, stress level, or irritation, which may also be useful inputs to the IVR analysis.

An output of whole-call analytics engine 380 may be a set of calls that are appropriately classified, tagged, and marked with prompts. The system may provide these calls to analyst dashboard 164.

A success model may be available to human analysts to determine which calls are successful and which are less successful. One important aspect of identifying call success is providing human analysts with a call browser that has calls tagged with the correct timestamps of IVR prompts and the correct taxonomy assigned to each identified prompt. Based on the success model, human analysts or an automated system may provide feedback, which is returned to the IVR solution provider to help improve the IVR.

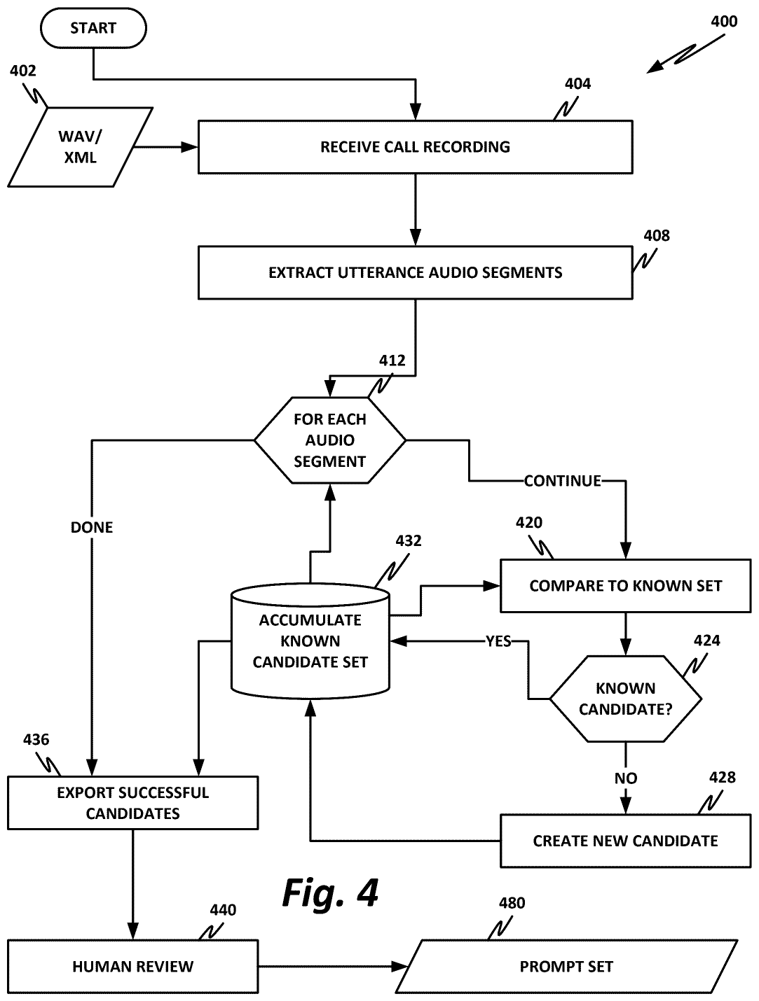

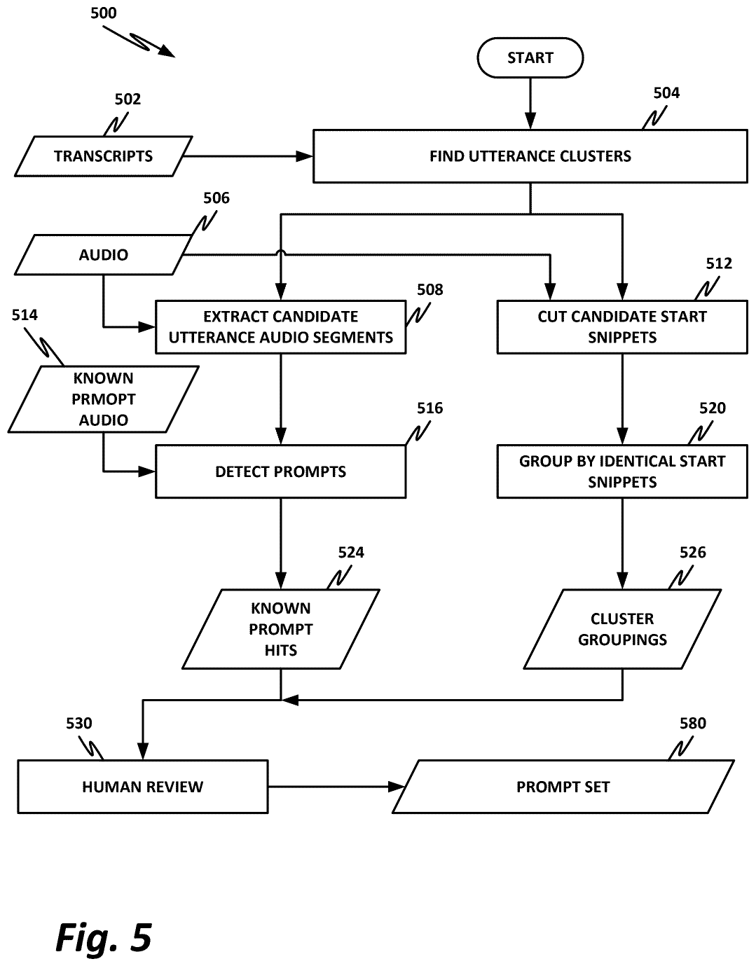

FIG. 4 and FIG. 5 provide flowcharts 400 and 500 respectively, which illustrate methods of automating prompt finding. The two methods illustrated herein may be used exclusively of each other or in conjunction with one another to provide faster and more efficient prompt finding. Prompt finding is an embodiment of prompt finding 216 (FIG. 2). However, this should be understood as a nonlimiting example. Prompt finding may, in some cases, be an iterative process that may be used throughout the call analysis framework. Thus, while prompt finding is used as an illustrative example of the methods herein, it can also be used in other contexts. In general terms, method 400 of FIG. 4 illustrates an audio analysis method for prompt finding. Method 500 of FIG. 5 represents a mixed audio and speech-to-text version of the process.

Turning to FIG. 4, method 400 illustrates processing of a single call within a call recordings batch. Thus, method 400 may be repeated many times on a large batch of calls to identify prompts within the calls.

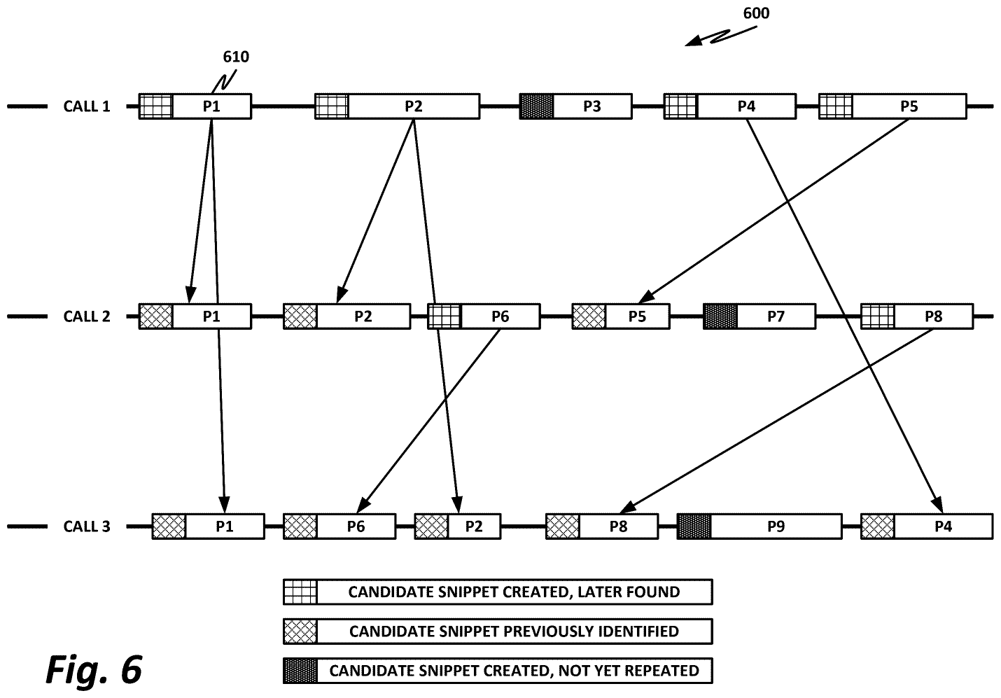

An understanding of method 400 may further be aided by referring to chart 600 of FIG. 6. Chart 600 illustrates an example graphing of a result of method 400. Within chart 600, a first call (Call 1) is analyzed and a plurality of utterances 610 are identified. These utterances may be discrete segments of audio delimited by periods of silence, or by transitions between non-IVR and IVR interactions or between different IVR interactions. Utterances may be identified, for example, by periods of silence or by changes in tone, speech patterns, or by other methods. Tokenization may refer to dividing a call into a plurality of utterances. Thus, in the example of graph 600, Call 1 is divided into utterances P1, P2, P3, P4, and P5. In some cases, utterances 610 may include only utterances believed to be IVR prompts while, in other cases, utterances 610 may include all discrete utterances including those that may be human speech. In some embodiments, a set of known IVR prompts may be preloaded into the system, if such data are available. For example, if the analysis service provider is also the original IVR software provider, then a set of prompts may already be known. However, in cases where the analysis service provider is not the original software vendor of the IVR system, or in cases where insufficient records exist to definitively identify prompts, an initial prompts set may not be available, or it may be incomplete.

For each utterance 610, the analysis system may extract an initial segment, such as a short clip of less than one second or, more particularly, 800 milliseconds. This short snippet may be understood to stand for the full IVR prompt. In cases where IVR prompts have the most significant variation beyond the beginning of the prompt, appropriate adjustments may be made in where the snippet is sampled, such as by identifying those prompts and separately categorizing them.

After analyzing Call 1, the system has a set of utterances 610 that are characterized by candidate snippets. The system has not yet determined whether these candidate snippets characterize valid prompts or whether they are other audio snippets, such as human speech or simply uninteresting prompts.

After analyzing Call 2, the system identifies that snippets P1, P2, and P5 were repeated in Call 2. This increases the likelihood that P1, P2, and P5 are IVR prompts because human variability in repeating any utterance is very unlikely to match audio sample by sample. Furthermore, within Call 2, the system identifies new candidate utterances P6, P7, and P8.

After analyzing Call 3, the system determines that utterances P1 and P2 were again repeated within the call. This further increases the likelihood that P1 and P2 are IVR prompts. The more calls that a candidate prompt appears in, the more likely it is to be an important prompt. Furthermore, Call 3 includes utterance P4, which was not included in Call 2. Utterances P6 and P8, first identified in Call 2, are also repeated in Call 3.

Thus, by the end of Call 3, utterances P1, P2, P4, P5, P6, and P8 are identified as likely IVR prompts because they have been matched in at least one other call. In this example, matched may be understood to mean that the initial snippet was matched, but it is possible that the rest of the utterance may be different across different calls. Again, in cases where IVR prompts have different text after the initial snippet, those can be dealt with as special cases.

Thus, when each call is analyzed, each utterance is either categorized as a recurrence of an existing candidate (which increases the likelihood of it being in IVR prompt), or the utterance becomes a new candidate prompt because it has not yet been encountered in the call set.

After three calls, utterances P3, P7, and P9 have not yet been repeated. Thus, these utterances may be human speech, or they may be IVR prompts that have not yet been repeated. Analysis of additional calls will help to further refine the identification of prompts and to eliminate utterances that do not recur, which could be rare inconsequential prompts or non-IVR audio.

Returning now to FIG. 4 and method 400 with a qualitative understanding of prompt finding, in block 404 the system receives a call recording for analysis. The call recording 402 may include audio of the call and may optionally include an XML transcript of the call. The XML transcript may be created, for example, by running speech-to-text detection on the call recording.

In block 408, the system parses the call into a plurality of audio segments, which typically correspond to utterances, but may include multiple segments per utterance, as would be required for conversational systems that include multiple items of interest in a single utterance. This may include tokenization as discussed previously.

Block 412 represents a loop that is performed on each audio segment in the call recording. In the continuation branch of loop 412, in block 420, the system may run prompt detection to compare the extracted audio segment against the known audio prompt candidate set.

Various parameters of comparison may be selected to avoid both false positives and false negatives. For example, when comparing against the known candidate set a difference in the start times of candidate prompts within the utterance audio segment may be permitted with a certain threshold, such as 0.5 seconds, or correlation acceptance threshold may be provided, where the audio segment correlates by at least a certain percentage, such as 70 percent, to a known candidate prompt in the audio set.

In decision block 424, the system determines whether the audio segment belongs to a known prompt candidate set. If the utterance does not match any known prompt candidate, then, in block 428, the system may identify the utterance as a new prompt candidate. This may include extracting a short snippet, such as 800 milliseconds, as a representative of the full audio segment. Creating a new prompt candidate may also include creating a candidate to add to the comparison pool to check for candidate successes. Alternatively, if the utterance does match a known prompt candidate, then, in block 432, the system may accumulate a counter for the prompt, incrementing the number of times the prompt candidate has been encountered.

In an illustrative process, the prompt finder may run prompt detection to determine if any known prompt candidates match the audio segment found, for example, via XML transcript lines, or if there is no match and a snippet cut from the audio segment should become a new prompt candidate.

Returning to loop 412, after each utterance within the recording has been analyzed, then the loop is complete.

In block 436, the system determines which utterances meet the requirements for being deemed an IVR prompt. A candidate prompt may be accepted as a good candidate if the threshold is above a given value, such as 50 matches. The threshold may be a scalar threshold (e.g., a minimum number of matches to be a good candidate), a prevalence threshold (e.g., to measure prevalence within the batch of calls), a weighted threshold, or any other criterion. A default snippet duration may be selected, such as 800 milliseconds. A successful match metric may be selected, such as 0.05 times the number of calls in the database. (In other words, a match is identified as a success if the utterance occurs in at least five percent of calls in the database). A successful match rate may be defined for the number of matches divided by the number of counts for a candidate, such as 0.5, and a flag may be defined to start with an existing known prompts set or to start from scratch. Successful candidates are exported to a set of successful candidates. The data may be exported in an appropriate format, such as a spreadsheet (e.g., an Excel spreadsheet or a CSV). The spreadsheet may include candidate transcript and creation information, a candidate count of hits, a candidate number of best matches, or other optional information. For example, the output may include the transcript at each best match found and candidate snippet context.

In block 440, a human review process may occur. For example, a human analyst may review, select, or create new prompts, as appropriate. The human analyst may also reject certain successful candidates as being false positives. Furthermore, if the human analyst determines that some prompts were missed as false negatives, those may be added to the prompt set. Thus, in some embodiments, prompt finding is neither fully automated nor fully manual, but is a cooperative effort between the automated system and the human analyst.

In block 480, the system exports a prompt set identified through the process that may be used later in the prompt detection method. These data may be provided both to the human analyst for refining the prompt set and may be provided to the next phase to aid in call tagging.

FIG. 5 is a flowchart of a method 500 that provides a second processing method for finding prompts. Method 500 may operate on transcripts 502 of a call set. Transcripts 502 may be generated using a human transcriptionist, or using a speech-to-text engine such as “Dragon” or similar technology.

Using text transcripts for comparison may have several advantages. For example, processing text can be orders of magnitude faster and use orders of magnitude fewer resources than processing audio snippets.

However, one challenge is that transcriptions are not always exact or exactly reproducible. In comparing audio snippets, the system relies on waveform similarity. But in comparing text snippets, the system looks for similar patterns in the text.

A simple or naïve system may rely on simply searching for identical text patterns between call transcriptions. Searches may be limited to utterances of no less than “len” length, to eliminate incomplete utterances, individual words, verbal hemming, or other less-useful information. In an example, utterances must be at least five words long (i.e., len=5). The naïve method may treat newly-identified utterances as candidate prompts (as illustrated in FIG. 6), and then accurately find the same prompts in a number of other text transcriptions. However, this naïve method may suffer from inexactness.

In cases where it is desirable to more accurately and consistently identify prompts, the system may not rely exclusively on finding identical text. Other methods may be employed, such as looking for text similarity (e.g., looking for words with a particular Levenshtein difference). While the Levenshtein difference can be useful in identifying words that have similar spelling, it may be less reliable in identifying words that have similar sounds but different spellings.

Thus, another method may use machine learning to identify similar blocks of text. One example is to look for utterances within a threshold of “len” words. Setting a minimum threshold of “len” words helps to avoid false positives by not matching very short phrases or single words. Thus, in an illustrative example, utterances of less than “len” words are discarded, and the remaining utterances are scanned. In this example, the concept of word embedding may be useful to find utterances with similar meaning. Word embedding is a known machine learning method that has contributed to the recent rise of NLP and LLM's.

In word embedding, each word is assigned a vector of real numbers that together represent the meaning of the word. The vector for each word may be on the order of tens or hundreds of real values, and represents the meaning of the word in a mathematical way that an ML algorithm can usefully process. One advantage of word embeddings (also known as word vectors) is that the meaning of an entire phrase can be represented by an average word vector. In this method, the word vectors for an utterance are averaged together (e.g., using a simple arithmetic mean) and an average word vector can be assigned to the entire phrase. When the average word vectors of two different phrases are within a threshold, the two phrases can be assumed to have similar meaning, even though the wording may be different (e.g., because of misspellings, synonyms, or inexactness).

An advantage of using an average word vector is that similar phrases will have similar average word vectors, even if some of the words are different. For example if the phrases have a nearly identical meaning, but use slight variations in language, the average word vector may still be similar enough that the phrases or utterances have similar average word vectors, and thus can be deemed similar. Furthermore, if a single word in the phrase is transcribed incorrectly, then the average word vector will be slightly affected, but if the other words remain in place then the average word vector may be similar enough that the meaning of the phrase can be accurately compared to similar phrases despite the slight mistranscription. Furthermore, even in cases where radical mistranscriptions occur (e.g., where a spanish phrase is mistranscribed into a nonsensical English phrase), the similar mistranscriptions can be grouped together, so that it is easier for a human analyst or an AI to recognize the issue and manually group the mistranscribed set with the correctly-transcribed set.

Using word embeddings can be very valuable in cases where volumes of text are transcribed as in the case of hundreds or thousands of call recordings being compared to one another. Transcription is generally an inexact process, so that transcribing two slightly different but very similar audio snippets may result in different transcriptions. This is especially true if two different human transcriptionists are transcribing, or if two different speech-to-text software packages are performing the transcription. However, this can be true even if the identical audio is transcribed. For example a human transcriptionist transcribing the same audio two different times may hear the text slightly differently between the two different times. Furthermore, because speech-to-text transcription has some built in variability and/or randomness, the same software transcribing the same audio twice may provide a slightly different transcription. Thus, it is advantageous to provide a comparison method that accounts for slight variations in phrasing, recording, or transcription.

Furthermore, an advantage of such a method is that it can identify audio prompts with near-identical meaning, even if they are worded slightly differently. Thus, word embedding may be used in cases where different versions of the IVR are rolled out, and the audio prompts change slightly between versions. As long as the meaning is sufficiently close, the two different phrases will still be grouped together as the same prompt, which may be appropriate in cases where the wording of a prompt was changed only slightly, while the intended meaning was retained.

In an illustrative example, block 504 includes finding utterance clusters. This may include looping through IVR/Queue transcripts and associated utterance embeddings. The system may compare each embedding against the full set of embeddings, using for example cosine similarity to create clusters of utterances that are similar in content within some tolerance. The system may also identify the most common transcribed version of utterances within the cluster. This most-common transcription may serve as a representative text label for the cluster. This is useful, for example, where the transcriptions are slightly different, or where the IVR wording was only slightly changed.

As clusters are found, especially if they are large, the system may then review remaining alternative transcripts in the cluster for other possible clusters to pull out. For instance, if a given non-representative transcript is found more often than some threshold, those utterances could be assigned to their own cluster or, if a set of transcripts in a large cluster differ only in insignificant ways, such as containing digit-strings or spelled words, those differences can be ignored and the transcripts could remain in the larger cluster. After the smaller, tighter clusters are removed from the initial larger cluster, the system can put the removed members back into the pool of unassigned transcripts and repeat the process. The remaining utterance set may be considered a final cluster and removed from the pool. The process continues in this fashion until no more clusters are found. Clusters below a certain size, or lone transcripts not close enough to form any cluster are not likely to be associated with any significant prompt and can be ignored.

Starting in blocks 508 and 512, the system may perform parallel or alternative operations. The operation started in block 508 may then identify known prompts in cluster representative utterances. In block 508, the system may use utterance start and end times from transcripts 502 to cut audio segments for each representative utterance from recorded call audio 506. In block 516, the system can then run prompt detection on representative candidate audio 508, using the currently active known audio prompts 514. This may result in a set of known prompt hits 524.

In parallel, the operation started in block 512 may also identify related cluster groups based on audio similarity at the beginning of cluster representative utterances. In block 512 the system may use representative utterance start times from transcripts 502 to cut representative utterance start audio snippets from recorded audio 506. For example, the system can cut the starting 800 ms of audio corresponding to each representative line. In block 520, to identify cluster groupings 526, the system may compare the starting snippets against each other, using successful prompt detections to determine which clusters belong in the same group.

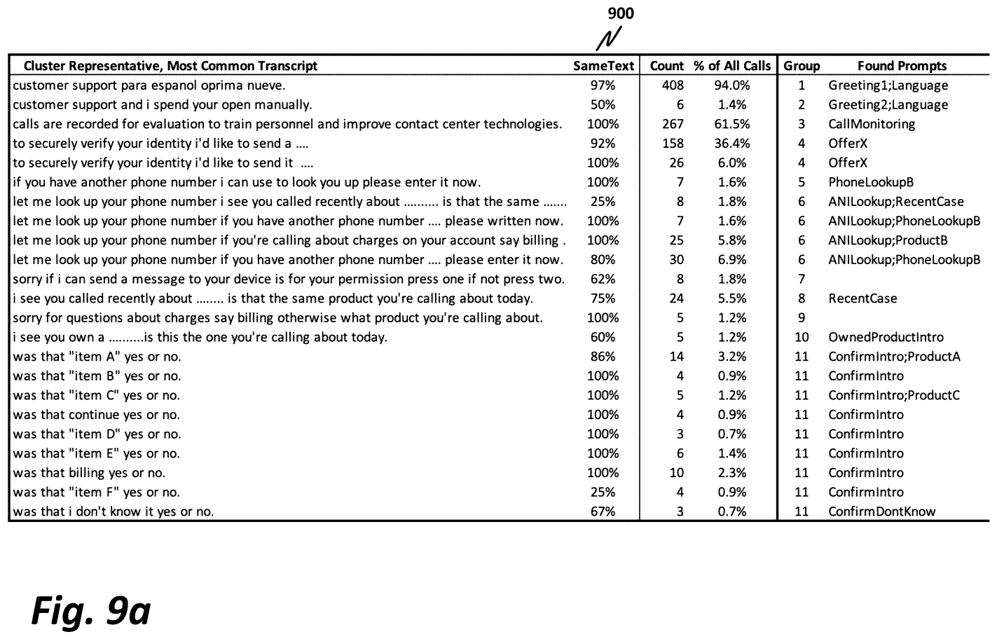

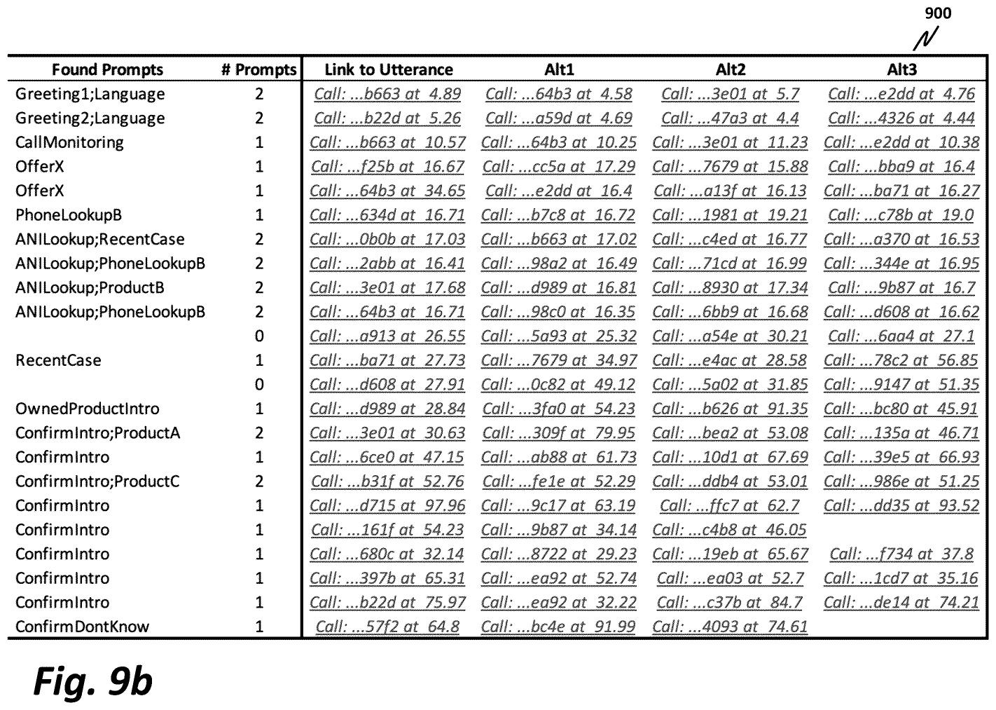

An output of this method may include a spreadsheet with the representative text for each cluster, exact text match rate, size of cluster, percentage of all calls that the prompt appears in, group number, prompts found within each cluster, and links to multiple utterance locations for possible prompt cutting. An illustrative example of such a spreadsheet output is illustrated in FIG. 9 as spreadsheet 900.

In block 530 a human analyst may review the results of clustering and grouping, as presented in spreadsheet 900, to provide quality assurance and to identify clusters that are not associated with any existing prompt, indicating that a new prompt may be needed, as well as clusters that belong to many groups, indicating that clarifying prompts later in those utterances might be helpful. The output is a set of candidate prompts 580, which can then be used to identify and cut whatever prompts are needed.

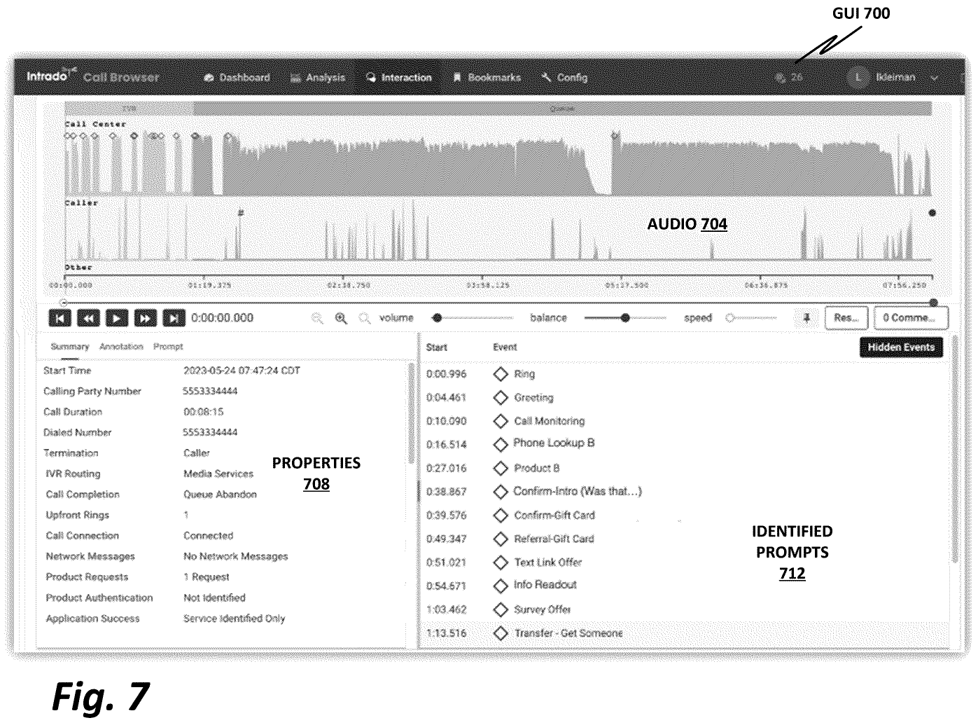

FIG. 7 is an illustrative graphical user interface (GUI) 700 that may form part of a call browser. The call browser can be used in an initial intake of a call set to review audio 704, and to tag a number of identified prompts 712 to the appropriate timestamps. A properties window 708 may also provide properties for the entire call.

As discussed above, prompt finding in existing systems is often a manual operation by human users. However, under the present specification, automatic prompt finding and prompt detection have already been performed, and the call may already be tagged with prompts at the appropriate timestamps in the appropriate prompt taxonomy. Thus, to the extent a human needs to interact with the prompt cutting, it may simply be a process of reviewing the work already performed by the computer.

GUI 700 may also be used in review and analysis, wherein a human operator reviews the call to assess its quality and provide feedback.

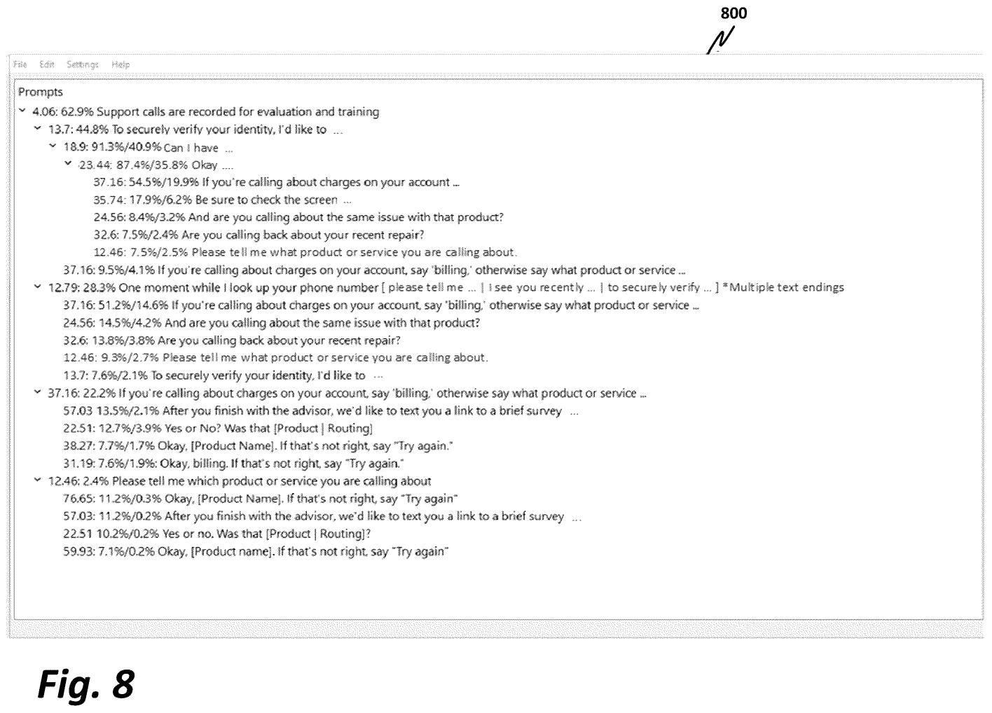

FIG. 8 provides an example of a display 800 that illustrates a taxonomy of identified prompts as typically generated by the audio prompt finder, method 400. Within the set of prompts, each prompt is assigned an identifier, which here appears as a decimal number at the start of each line, wherein for example the value before the decimal may identify a major classification, and the value after the decimal may identify a minor classification.

In this example, the prompt finder found 50 successful prompts with at least 25 “good” hits in approximately 1000 calls, although not all are displayed in this figure. The taxonomy displays a manual construction of 3 to 5 levels of the early call flow for prompts that occur in at least 7% of calls. Note that some of the prompts appeared on multiple paths. For each identified prompt, the system provides not only the taxonomic identification which, in this case, is the initial start time, but also the relative and absolute percentage of calls in which the prompt occurred. When only one number is supplied, it is the absolute percentage of calls. For example 62.9% of all calls included a prompt notifying the caller that support calls are recorded for evaluation and training.

These prompts then flow into a tree in which some prompts are repeated in different branches. The tree illustrates a flow of logic for the customer support service. A human operator may evaluate a call to determine what branches of the tree were followed, and whether the call was considered a success.

FIGS. 9a and 9b illustrate a spreadsheet 900, spread across two pages where the Found Prompts column is repeated on both pages. The spreadsheet may be an output of an analysis of IVR and Queue utterances identified by a representative or most common transcription. This may apply particularly to the method 500 of FIG. 5. As discussed above, a most-common text transcription is used to represent clusters. In this case, a representative prompt includes instructions that to receive support in

Spanish, the user should press “9.” Because this prompt is provided in all or almost all calls, in this example the text appeared in 94% of calls. Another 1.4% had similar starting text, but what followed was mistranscribed as “and I spend your open it manually.” While this nonsense transcription is different from “para espanol, oprima nueve,” the incorrect transcriptions were grouped together based on the detection of similar prompt patterns.

In this spreadsheet, utterances are clustered first by similarity of whole-utterance metrics (e.g., the average word embedding for the utterance). Clusters may then be grouped by similarity of the first 800 ms of audio, which can bind groups of incorrect transcriptions to correct transcriptions, as in the case of the mistranscribed Spanish prompt above. Then the system may, for multiple members of each cluster, identify points within the utterance recordings where prompt snippets may be taken. In this case, the spreadsheet, as continued in FIG. 9b, may also provide hyperlinks to specific locations within the audio where the prompt was identified.

The system may then involve human review to select a suitable prompt snippet. For example, human analysts may review the alternative prompt candidates to find the most suitable candidate. Analysts may also adjust snippet boundaries to capture the strongest and most distinctive audio.

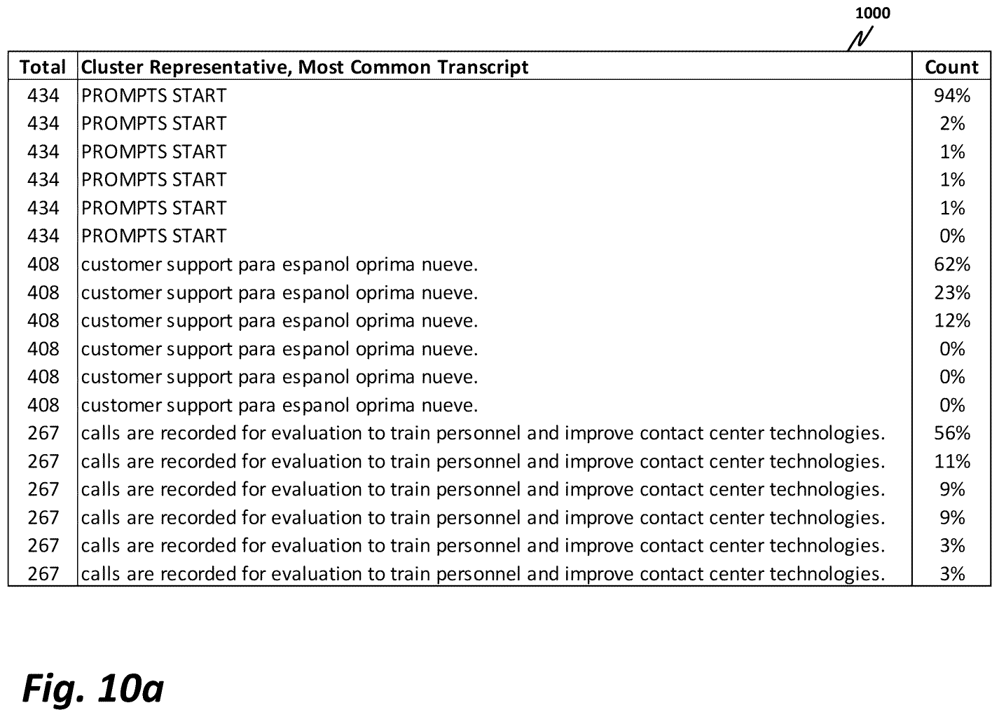

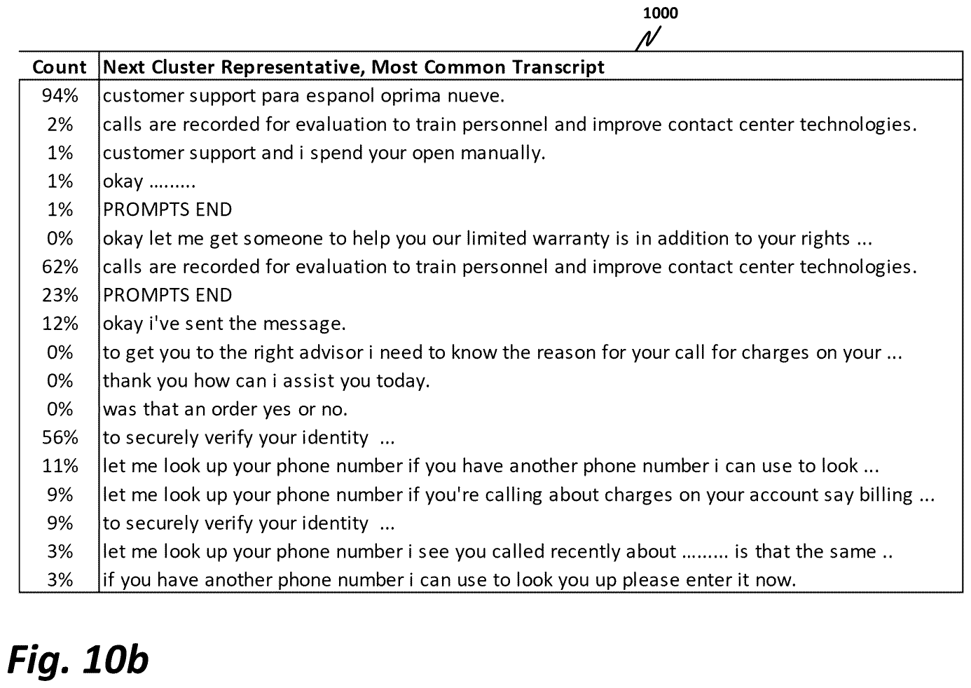

FIGS. 10a and 10b illustrate an additional spreadsheet 1000. In spreadsheet 1000, clusters correspond to call flow states, and their order reflects the call flow logic tree. For each cluster (including the START and END of the call), spreadsheet 1000 shows the possible next cluster, and how commonly the path occurs. Human analysts can use the cluster connections to understand and designate call flow trees.

FIG. 11 is a block diagram of a hardware platform 1100. Hardware platform 1110 may provide the physical architecture to run an instance of a machine or apparatus programmed to provide the automated prompt detection methods disclosed herein. Hardware platform 1100 may also provide a suitable environment for running the various GUIs illustrated, such as a call browser, and to interact with human analysts to provide prompt detection and cutting.

Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 1100, even though they may be scattered across a data center, or even located in different data centers.

Hardware platform 1100 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 1100 is arranged in a point-to-point (PtP) configuration. This PtP configuration is popular for personal computer (PC) and server-type devices, although it is not so limited, and any other bus type may be used.

Hardware platform 1100 is an example of a platform that may be used to implement embodiments of the teachings of this specification. For example, instructions could be stored in storage 1150. Instructions could also be transmitted to the hardware platform in an ethereal form, such as via a network interface, or retrieved from another source via any suitable interconnect. Once received (from any source), the instructions may be loaded into memory 1104, and may then be executed by one or more processor 1102 to provide elements such as an operating system 1106, operational agents 1108, or data 1112.

Hardware platform 1100 may include several processors 1102. For simplicity and clarity, only processors PROC0 1102-1 and PROC1 1102-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 1102 may be any type of processor and may communicatively couple to chipset 1116 via, for example, PtP interfaces. Chipset 1116 may also exchange data with other elements, such as a high performance graphics adapter 1122. In alternative embodiments, any or all of the PtP links illustrated in FIG. 11 could be implemented as any type of bus, or other configuration rather than a PtP link. In various embodiments, chipset 1116 may reside on the same die or package as a processor 1102 or on one or more different dies or packages. Each chipset may support any suitable number of processors 1102. A chipset 1116 (which may be a chipset, uncore, Northbridge, Southbridge, or other suitable logic and circuitry) may also include one or more controllers to couple other components to one or more central processor units (CPU).

Two memories, 1104-1 and 1104-2 are shown, connected to PROC0 1102-1 and PROC1 1102-2, respectively. As an example, each processor is shown connected to its memory in a direct memory access (DMA) configuration, though other memory architectures are possible, including ones in which memory 1104 communicates with a processor 1102 via a bus. For example, some memories may be connected via a system bus, or in a data center, memory may be accessible in a remote DMA (RDMA) configuration.

Memory 1104 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 1104 may be used for short, medium, and/or long-term storage. Memory 1104 may store any suitable data or information utilized by platform logic. In some embodiments, memory 1104 may also comprise storage for instructions that may be executed by the cores of processors 1102 or other processing elements (e.g., logic resident on chipsets 1116) to provide functionality.

In certain embodiments, memory 1104 may comprise a relatively low-latency volatile main memory, while storage 1150 may comprise a relatively higher-latency nonvolatile memory. However, memory 1104 and storage 1150 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 1104 and storage 1150, for example, in a single physical memory device, and in other cases, memory 1104 and/or storage 1150 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 1122 may be configured to provide a human-readable visual output, such as a command-line interface (CLI) or graphical desktop such as Microsoft Windows, Apple OSX desktop, or a Unix/Linux X Window System-based desktop. Graphics adapter 1122 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 1122 may include a hardware graphics card, which may have its own memory and its own graphics processing unit (GPU).

Chipset 1116 may be in communication with a bus 1128 via an interface circuit. Bus 1128 may have one or more devices that communicate over it, such as a bus bridge 1132, I/O devices 1135, accelerators 1146, communication devices 1140, and a keyboard and/or mouse 1138, by way of nonlimiting example. In general terms, the elements of hardware platform 1100 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 1140 can broadly include any communication not covered by a network interface and the various I/O devices described herein. This may include, for example, various universal serial bus (USB), FireWire, Lightning, or other serial or parallel devices that provide communications.

I/O Devices 1135 may be configured to interface with any auxiliary device that connects to hardware platform 1100 but that is not necessarily a part of the core architecture of hardware platform 1100. A peripheral may be operable to provide extended functionality to hardware platform 1100, and may or may not be wholly dependent on hardware platform 1100. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 1142 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 1132 may be in communication with other devices such as a keyboard/mouse 1138 (or other input devices such as a touch screen, trackball, etc.), communication devices 1140 (such as modems, network interface devices, peripheral interfaces such as PCI or PCIe, or other types of communication devices that may communicate through a network), audio I/O 1142, a data storage device 1144, and/or accelerators 1146. In alternative embodiments, any portions of the bus architectures could be implemented with one or more PtP links.

Operating system 1106 may be, for example, Microsoft Windows, Linux, UNIX, Mac OS X, IOS, MS-DOS, or an embedded or real-time operating system (including embedded or real-time flavors of the foregoing). In some embodiments, a hardware platform 1100 may function as a host platform for one or more guest systems that invoke application (e.g., operational agents 1108).

Operational agents 1108 may include one or more computing engines that may include one or more nontransitory computer-readable mediums having stored thereon executable instructions operable to instruct a processor to provide operational functions. At an appropriate time, such as upon booting hardware platform 1100 or upon a command from operating system 1106 or a user or security administrator, a processor 1102 may retrieve a copy of the operational agent (or software portions thereof) from storage 1150 and load it into memory 1104. Processor 1102 may then iteratively execute the instructions of operational agents 1108 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 1100 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QuickPath Interconnect, QPI, or KTI), FibreChannel, Ethernet, FibreChannel over Ethernet (FCOE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 1100 may be virtualized, in particular the processor(s) and memory. For example, a virtualized environment may run on OS 1106, or OS 1106 could be replaced with a hypervisor or virtual machine manager. In this configuration, a virtual machine running on hardware platform 1100 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 11 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIGURE QC. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

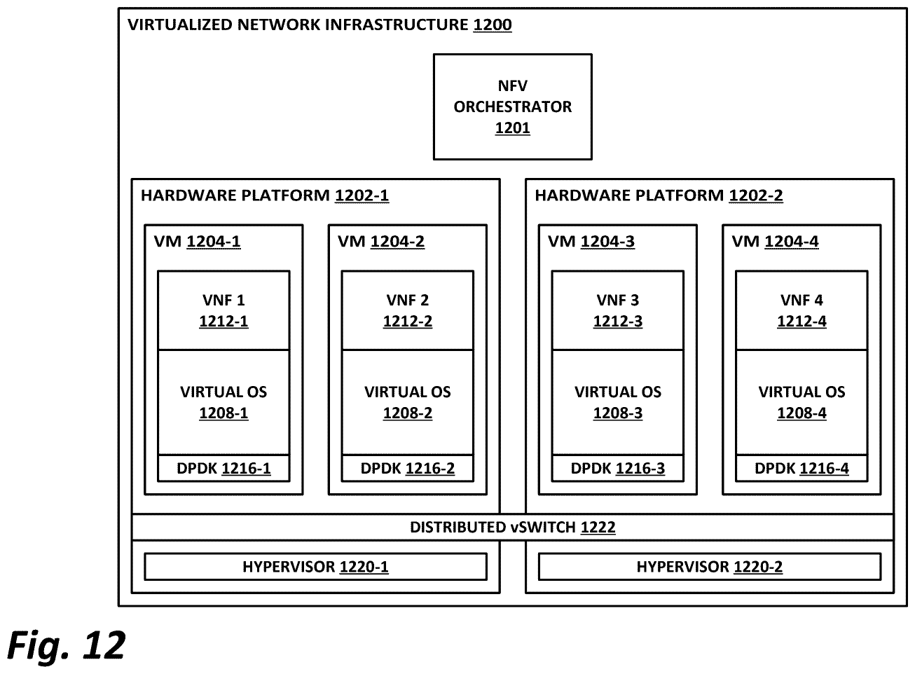

FIG. 12 is a block diagram of a NFV infrastructure 1200. NFV is an example of virtualization, and the virtualization infrastructure here can also be used to realize traditional VMs. Various functions described above may be realized as VMs. For example, one of more of the call detection features illustrated above may be realized within one or more virtual machines.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 1200. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 12, an NFV orchestrator 1201 may manage several VNFs 1212 running on an NFVI 1200. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 1201 a valuable system resource. Note that NFV orchestrator 1201 may provide a browser-based or graphical configuration n interface, and in some embodiments may be integrated with SDN orchestration functions.

Note that NFV orchestrator 1201 itself may be virtualized (rather than a special-purpose hardware appliance). NFV orchestrator 1201 may be integrated within an existing SDN system, wherein an operations support system (OSS) manages the SDN. This may interact with cloud resource management systems (e.g., OpenStack) to provide NFV orchestration. An NFVI 1200 may include the hardware, software, and other infrastructure to enable VNFs to run. This may include a hardware platform 1202 on which one or more VMs 1204 may run. For example, hardware platform 1202-1 in this example runs VMs 1204-1 and 1204-2. Hardware platform 1202-2 runs VMs 1204-3 and 1204-4. Each hardware platform 1202 may include a respective hypervisor 1220, virtual machine manager (VMM), or similar function, which may include and run on a native (bare metal) operating system, which may be minimal so as to consume very few resources. For example, hardware platform 1202-1 has hypervisor 1220-1, and hardware platform 1202-2 has hypervisor 1220-2.

Hardware platforms 1202 may be or comprise a rack or several racks of blade or slot servers (including, e.g., processors, memory, and storage), one or more data centers, other hardware resources distributed across one or more geographic locations, hardware switches, or network interfaces. An NFVI 1200 may also include the software architecture that enables hypervisors to run and be managed by NFV orchestrator 1201.

Running on NFVI 1200 are VMs 1204, each of which in this example is a VNF providing a virtual service appliance. Each VM 1204 in this example includes an instance of the Data Plane Development Kit (DPDK) 1216, a virtual operating system 1208, and an application providing the VNF 1212. For example, VM 1204-1 has virtual OS 1208-1, DPDK 1216-1, and VNF 1212-1. VM 1204-2 has virtual OS 1208-2, DPDK 1216-2, and VNF 1212-2. VM 1204-3 has virtual OS 1208-3, DPDK 1216-3, and VNF 1212-3. VM 1204-4 has virtual OS 1208-4, DPDK 1216-4, and VNF 1212-4.

Virtualized network functions could include, as nonlimiting and illustrative examples, firewalls, intrusion detection systems, load balancers, routers, session border controllers, DPI services, network address translation (NAT) modules, or call security association.

The illustration of FIG. 12 shows that a number of VNFs 1204 have been provisioned and exist within NFVI 1200. This FIGURE does not necessarily illustrate any relationship between the VNFs and the larger network, or the packet flows that NFVI 1200 may employ.

The illustrated DPDK instances 1216 provide a set of highly-optimized libraries for communicating across a virtual switch (vSwitch) 1222. Like VMs 1204, vSwitch 1222 is provisioned and allocated by a hypervisor 1220. The hypervisor uses a network interface to connect the hardware platform to the data center fabric (e.g., a host fabric interface (HFI)). This HFI may be shared by all VMs 1204 running on a hardware platform 1202. Thus, a vSwitch may be allocated to switch traffic between VMs 1204. The vSwitch may be a pure software vSwitch (e.g., a shared memory vSwitch), which may be optimized so that data are not moved between memory locations, but rather, the data may stay in one place, and pointers may be passed between VMs 1204 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 1222 is illustrated, wherein vSwitch 1222 is shared between two or more physical hardware platforms 1202.

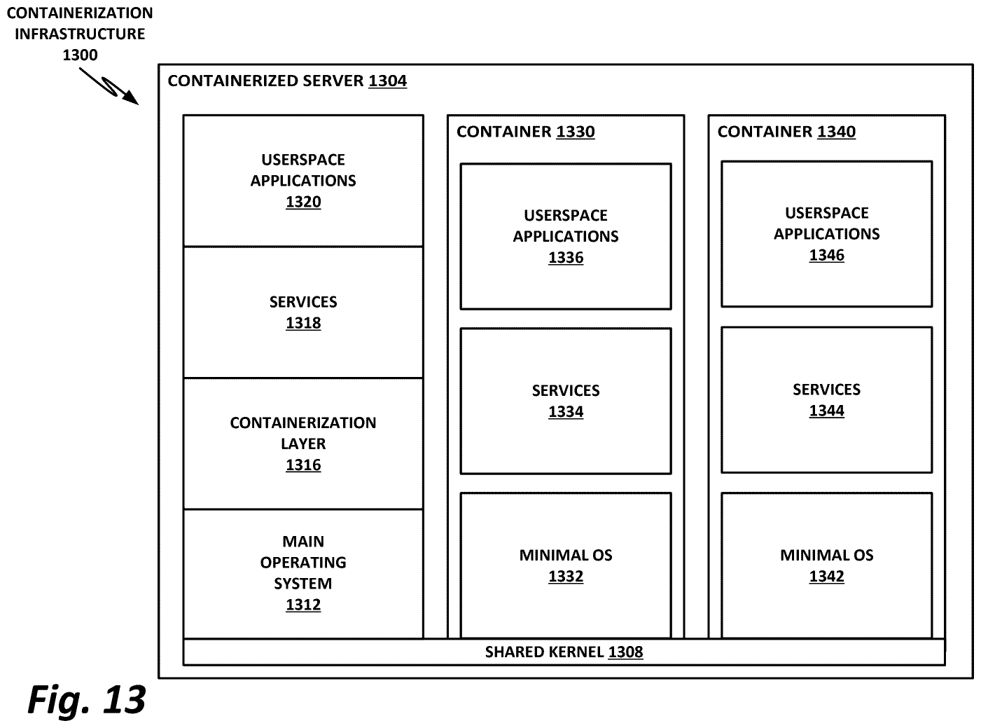

FIG. 13 is a block diagram of selected elements of a containerization infrastructure 1300. Like virtualization, containerization is a popular form of providing a guest infrastructure. Various functions described herein may be containerized. For example, a microservices architecture may be used to provide automated call detection within a data center or in the cloud.

Containerization infrastructure 1300 runs on a hardware platform such as containerized server 1304. Containerized server 1304 may provide processors, memory, one or more network interfaces, accelerators, and/or other hardware resources.

Running on containerized server 1304 is a shared kernel 1308. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1308 is main operating system 1312. Commonly, main operating system 1312 is a Unix or Linux-based operating system, although containerization infrastructure is also available for other types of systems, including Microsoft Windows systems and Macintosh systems. Running on top of main operating system 1312 is a containerization layer 1316. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 1312 may also provide services 1318, which provide services and interprocess communication to userspace applications 1320.

Services 1318 and userspace applications 1320 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1312, they inherit the same file and resource access permissions as those provided by shared kernel 1308. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1304, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1304).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare metal,” hypervisors—provide such near-native performance that this advantage may not always be realized.

In this example, containerized server 1304 hosts two containers, namely container 1330 and container 1340.

Container 1330 may include a minimal operating system 1332 that runs on top of shared kernel 1308. Note that a minimal operating system is provided as an illustrative example, and is not mandatory. In fact, container 1330 may perform as full an operating system as is necessary or desirable. Minimal operating system 1332 is used here as an example simply to illustrate that in common practice, the minimal operating system necessary to support the function of the container (which in common practice, is a single or monolithic function) is provided.

On top of minimal operating system 1332, container 1330 may provide one or more services 1334. Finally, on top of services 1334, container 1330 may also provide userspace applications 1336, as necessary.

Container 1340 may include a minimal operating system 1342 that runs on top of shared kernel 1308. Note that a minimal operating system is provided as an illustrative example, and is not mandatory. In fact, container 1340 may perform as full an operating system as is necessary or desirable. Minimal operating system 1342 is used here as an example simply to illustrate that in common practice, the minimal operating system necessary to support the function of the container (which in common practice, is a single or monolithic function) is provided.

On top of minimal operating system 1342, container 1340 may provide one or more services 1344. Finally, on top of services 1344, container 1340 may also provide userspace applications 1346, as necessary.

Using containerization layer 1316, containerized server 1304 may run discrete containers, each one providing the minimal operating system and/or services necessary to provide a particular function. For example, containerized server 1304 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

The foregoing outlines features of several embodiments so that those skilled in the art may better understand various aspects of the present disclosure. The foregoing detailed description sets forth examples of apparatuses, methods, and systems relating to a system for automated prompt finding in accordance with one or more embodiments of the present disclosure. Features such structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random-access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is not intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected elements. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

1-58. (canceled)

59. A computer-assisted method of identifying prompts from a batch of recorded interactive voice response (IVR) calls, comprising:
identifying, within a call under analysis, a plurality of discrete utterances;
electronically comparing a selected utterance to a set of known prompt candidates, wherein the known prompt candidates are candidates for being IVR prompts;
based on the comparing, determining that the selected utterance clusters with a known prompt candidate cluster, and accumulating a counter for the known prompt candidate cluster; and
after processing the batch, identifying a set of good prompt candidates, wherein good prompt candidates have a counter above a threshold.

60. The computer-assisted method of claim 59, further comprising determining that the selected utterance does not cluster with a known prompt candidate, and designating the selected utterance as a prompt candidate.

61. The computer-assisted method of claim 59, wherein the threshold is a scalar threshold.

62. The computer-assisted method of claim 59, wherein the threshold is a prevalence threshold.

63. The computer-assisted method of claim 59, wherein the discrete utterances are delimited by silence.

64. The computer-assisted method of claim 59, wherein the discrete utterances are delimited by silence above a threshold length.

65. The computer-assisted method of claim 59, wherein electronically comparing comprises comparing audio waveforms.

66. The computer-assisted method of claim 59, wherein electronically comparing comprises comparing call transcripts.

67. The computer-assisted method of claim 66, wherein comparing call transcripts comprises comparing average word embeddings for utterances.

68. The computer-assisted method of claim 67, wherein comparing call transcripts comprises comparing for cosine similarity.

69. The computer-assisted method of any of claim 59, further comprising outputting a matrix of the good prompt candidates.

70. The computer-assisted method of claim 69, further comprising cutting short initial snippets for the good prompt candidates.

71. The computer-assisted method of claim 70, wherein the short initial snippets are approximately 800 milliseconds.

72. The computer-assisted method of claim 59, further comprising tagging a set of call recordings with timestamps of identified IVR prompts within the call recordings.

73. The computer-assisted method of claim 59, further comprising supplementing prompt identification with additional human analysis.

74. One or more tangible, nontransitory computer-readable storage media having stored thereon executable instructions to instruct a processor circuit to:
receive a batch of interactive voice response (IVR) call recordings;
identify, within a selected call from the batch, a plurality of utterances;
electronically compare a selected utterance to a set of previously-identified IVR prompt candidates;
based on the comparing, determine that the selected utterance clusters into a previously-identified prompt candidate cluster, and increasing a count for the candidate cluster; and
after processing the batch, identify a set of good prompt candidates, based on counts for the candidate clusters.

75. The one or more tangible, nontransitory computer-readable media of claim 74, wherein the instructions are further to determine that the selected utterance does not cluster with a known prompt candidate, and designating the selected utterance as a prompt candidate.

76. The one or more tangible, nontransitory computer-readable media of claim 74, wherein the plurality of utterances are delimited by silence above a threshold length.

77. A computing apparatus for automatically identifying prompts within a batch of recordings of interactive voice response (IVR) calls, comprising:
a hardware platform comprising a processor circuit and a memory; and
instructions encoded within the memory to instruct the processor circuit to:
identify, within a selected call from the batch, a plurality of utterances;
electronically compare a selected utterance to a set of previously-identified IVR prompt candidates;
based on the comparing, determine that the selected utterance clusters into a previously-identified prompt candidate cluster, and increasing a count for the candidate cluster; and
after processing the batch, identify a set of good prompt candidates, based on counts for the candidate clusters.

78. The computing apparatus of claim 77, wherein the instructions are further to determine that the selected utterance does not cluster with a known prompt candidate, and designating the selected utterance as a prompt candidate.
